(19) United States
(12) Patent Application Publication
(10) Pub. No.: US 2005/0252757 A1
(43) Pub. Date: Nov. 17, 2005

(54) Residential circuit breaker having a tripped switch indicator means

(76) Inventor: Galen J. May, Reno, NV (US)

Correspondence Address: Galen J. May, 7630 Tholl Drive, Reno, NV, 89506, US

(21) Appl. No.: 10/846,884

(22) Filed: May 14, 2004

(51) Int. Cl. H01H 9/00

(52) U.S. Cl. 200/308

(57) ABSTRACT

A modification for improving a typical pre-existing residential circuit breaker which when modified includes a tripped switch indicator such as an illuminating light or an audible alarm. The indicator includes a container for containment of a light source and a resistor therein. The container having an end cap that may be frictionally engaged within a receptacle formed on the circuit breaker. The end cap having a first and second contact pin and the light having first and second electrical leads for electrical communication between each contact pin, a contact clamp and a contact nut.

### FIELD OF THE INVENTION

This invention relates to circuit breakers in general but more particularly pertains to a prior art plug in type circuit breaker typically associated with residential circuit breaker boxes. However, the circuit breaker further includes a tripped switch indicator means and appropriate circuitry in combination therewith. Whereby, when the tripped switch indicator means is installed within the circuit breaker, the tripped switch indicator means is automatically actuated when the circuit breaker has been tripped or triggered, so as to either visually or audibly notify the user thereof which circuit breaker needs resetting.

### BACKGROUND OF THE INVENTION

It is well known within the field that when a circuit breaker has been tripped, it can be quite time consuming and difficult to locate the tripped breaker switch, especially under circumstances during the night, or in the dark where no exterior lighting is provided. In such a situation it can be extremely difficult and irritating when one is trying to determine which of the circuit breakers must be reset and/or they simply can't see the circuit breakers, or the circuit breaker switches are not easily accessible.

It is therefore contended by the applicant that it would be most advantageous and desirable to provide an efficient, easily installed tripped switch indicator means that can be installed within the actual prior art circuit breaker housing at the point of manufacture. Whereby, when the tripped switch indicator means and the circuit breaker are combined and installed in within an electrical circuit, the tripped switch indicator means is automatically actuated when the associated circuit breaker has been disabled, or tripped respectively. Thus, this would be extremely helpful and eliminate guesswork for the user as well as save time and wasted energy.

Within the known prior art there have been attempts made to include a light indicator source either within a fuse housing or within a fuse adaptor but nowhere in the prior art did the applicant find use of a tripped switch indicator means and a circuit breaker in combination such as taught by the present invention.

The following are exemplary prior art references relating to blown fuse indicators such as found within the field of the present invention. U.S. Pat. No. 5,311,139 teaches a “FUSE CHECKER FOR TESTING INTEGRITY OF A MINIATURE, PLUG-IN FUSE WHILE THE FUSE IS INSTALLED IN AN ELECTRICAL CIRCUIT”. This reference is functional for its intended purpose and that is to “test” the condition of a fuse. The test is performed by using a checker which includes a housing from which extends a pair of parallel contact points adapted for engagement with terminal tabs that lie within terminal access openings within a plug-in type fuse housing and in practice, the user must manually insert the checker and apply constant pressure upon the terminal tabs while the test is performed and if a fuse is blown, one of two LED's located on the checker housing will illuminate, and if the fuse is not blown, both LED's on the checker will illuminate. This checker device is not to be used and/or installed on a permanent basis. It is only usable for performing the described test. This reference is therefore limited in use and could not be installed on a permanent basis, as can the present invention.

Various types of spring clips have been taught for securing a blown fuse light indicator to a cartridge fuse as indicated by U.S. Pat. Nos. “3,432,789 and 3,457,535.” However, these references have addressed only cartridge type fuse holders and in each case additional limiting resistors are required and/or a separate plug is required, and each would not be attachable or functional if used on a plug-in type circuit breaker. It is common knowledge that in most cases, the plug-in type circuit breaker has become the embodiment of choice, such as found within most electrical fuse boxes used within most modern day residential applications.

It is to be noted that within my previously issued U.S. Pat. No. 5,701,118, I provide a similar device which is an indicator cap that is removably attachable onto a prior art plug-in type fuse, and the cap having an indicator light for signaling that a fuse has blown so as to notify a user of the blown condition of the fuse. However, this invention is only similar in function and it is limited to use with only non-residential fuse panels, such as those associated with automobiles and the like.

### SUMMARY OF THE INVENTION

It is therefore a primary object of the present invention to provide an installation method for installing a tripped switch indicator means within the pre-existing housing and associated circuitry contained within the circuit breaker at the point of manufacture. Whereby when modified, provides an indication means that is automatically activated upon detection of a tripped switch associated with a circuit breaker due to a power overload or the like.

It is another object of the present invention to provide a tripped switch indicator means that may be of any suitable type depending on engineering choice, such as a neon light, which is preferred, or candescent, incandescent, etc., or it may be in the form of a buzzer or the like. For safety purposes it is to be understood the noted indicator means is to be removable for servicing if applicable.

Other objects and advantages will be seen when taken into consideration with the following drawings and specification.

### BRIEF DESCRIPTION OF THE DRAWINGS

FIG. 1 is substantially an overview partially depicting a prior art circuit breaker with its on/off switch mechanism being in the “on” position and functional.

FIG. 2 is substantially an overview partially depicting a prior art circuit breaker with its on/off switch mechanism being in the “off” position and not functional.

FIG. 3 substantially depicts the prior art circuit breaker when modified with the present invention.

FIG. 4 is substantially an enlarged view of the tripped switch indicator means after being installed within the noted circuit breaker.

### DETAILED DESCRIPTION OF THE DRAWINGS

Referring now in detail to the drawings wherein like characters refer to like elements throughout the various views.

Referring now to FIG. 1, wherein a typical pre-existing prior art circuit breaker (10) is partially depicted. Therein, the circuit breaker (10) as illustrated has its normal cover plate (not shown) removed for clarity purposes. However, it is to be understood the normal pre-existing prior art circuit breaker (10) typically includes a cover plate. As can be seen, prior art circuit breaker (10) provides a housing (12) having an internal compartment (14) for containment of electrical components typically associated with the prior art circuit breaker (10). It is to be further understood that the noted electrical components include but are not limited too an on/ff switch mechanism (16), a contact nut (18) and a contact clamp (20) each of which are shown in ghost lines as they are considered prior art.

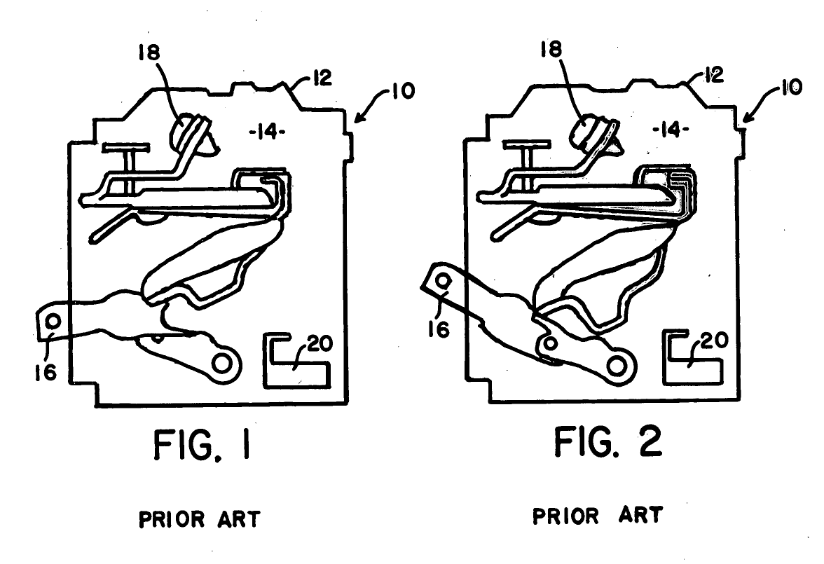

In operation, on/off switch mechanism (16) when in the “on” position as depicted in FIG. 1, indicates a non-tripped condition for circuit breaker (10) and when the on/off switch mechanism is in the “off” position as depicted in FIG. 2, indicates a tripped condition.

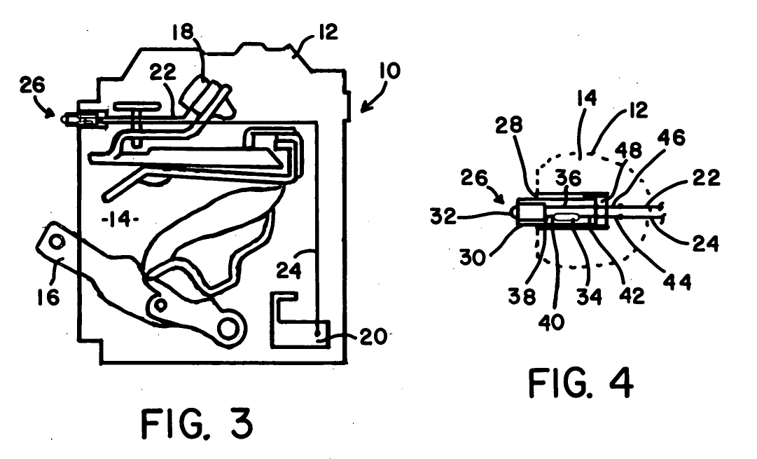

It is to be understood that when tripped switch indicator (latter described in detail) is installed within housing (12) it is in electrical communication with contact nut (18) via a first electrical lead (22) and tripped switch indicator when installed is in electrical communication with contact clamp (20) via a second electrical lead (24), as can be seen in FIG. 3. Whereby, when on/off switch mechanism (16) is in the “on” position, tripped switch indicator is not activated, and when on/off switch mechanism (16) is in the “off” position tripped switch indicator is activated.

It is to be further understood that the actual construction and arrangement for installing the noted tripped switch indicator may be incorporated in numerous ways. Thus, the preferred embodiment (as taught hereafter) is only exemplary of one possible embodiment of choice. Therefore the invention is not to be limited thereto. The general overview of the present invention is simply to include a tripped switch indicator within the housing of the prior art circuit breaker (10) and anyway of incorporating such is inherent.

Referring now to the exemplary embodiment for construction and installation of the tripped switch indicator (26) as depicted in FIGS. 3 & 4. Wherein, housing (12) of prior art circuit breaker (10) includes a receptacle (28) for receiving tripped switch indicator (26) therein. Any suitable type of receptacle of engineering choice may be incorporated, as there are numerous types to choose from.

With reference now in particular to FIG. 4, wherein tripped switch indicator (26) as depicted is enlarged and more clearly defined as follows: Tripped switch indicator substantially comprising a container (30) for containment of a light source (32) and a resistor (34) therein and container (30) further including attachment means (latter described) for attaching tripped switch indicator (26) onto receptacle (28). Light source (32) having a first lead (36) and a second lead (38) and resister (34) also having a first lead (40) and a second lead (42). The second lead (38) of light source (32) being connected onto first lead (40) of resistor (34) by suitable attachment means of choice such as soldering or the like, (not shown) for clarity purposes. The second lead (42) of resistor (34) being connected onto a first contact pin (44) by suitable attachment means of choice such as soldering or the like, (not shown) for clarity purposes. First contact pin (44) is in electrical communication with contact clamp (20), as shown in FIG. 3 via second electrical lead (24). First lead (36) of light source (32) is connected onto a second contact pin (46) by suitable attachment means of choice such as soldering or the like, (not shown) for clarity purposes and second contact pin (46) is in electrical communication with contact nut (18) via first electrical lead (22).

It is to be noted the previously stated attachment means for attaching tripped switch indicator (26) onto receptacle (28) can be of any suitable type depending on engineering choice and thus the invention is not to be limited to the following description, as herein is only exemplary of one possible attachment means. As depicted, the attachment means for attaching tripped switch indicator (26) includes an end cap (48) that is of a shape and size to be frictionally engaged within receptacle (28) and each contact pin (44 & 46) project outwardly from within end cap (48) and when tripped switch indicator (26) is installed each contact pin (44 & 46) protrude into the receptacle (28) thus completing the electrical circuit. It can now be seen that when switch mechanism (16) is operating and in the “on” position, light source (32) does not illuminate. However, when switch mechanism (16) assumes the “off” position, light source (32) automatically illuminates so as to visually notify a user which circuit breaker needs resetting. In this embodiment it is preferred but not a necessity that the container (30) be transparent. Also, it is to be noted that the light source (32) and/or tripped switch indicator (26) is preferably removably engaged within receptacle (28) for servicing purposes as well as safety reasons.

It is to be further understood that the noted tripped switch indicator as herein preferred is in the form of a light source, such as neon, candescent, incandescent, or the like. However, the preferred indicator may also me in the form of a buzzer, whistle, or any other type of audio alarm if so desired.

Furthermore, with reference to the noted electrical leads (22 & 24) it is to be noted the actual housing (12) may be modified at the point of manufacture to include apertures (not shown) for protecting the leads when positioned therein, such as from overheating or the like. Also, within FIG. 3 the noted leads are threadably installed (for clarity purposes) in between the existing circuitry and electrical components. However, in production other suitable means for installing the leads would include optional choices for their engagement in between the existing circuitry, etc. Thus the invention is not to be limited to how installation of the leads may be incorporated, as numerous installation means are inherent.

It will now be seen herein disclosed is a new and improved circuit breaker including indicator means in combination therewith for either visual or audible notification to inform a user which circuit breaker needs resetting in a manner heretofore not taught.

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatuses.

1-5. (canceled)

6. A tripped switch indicator for use in combination with a pre-existing residential circuit breaker having a housing with an internal compartment for containment of electrical components associated therewith, the electrical components including an on/off switch mechanism, a contact nut, and a contact clamp, said tripped switch indicator comprising: a container; a light source; a resistor; an end cap; a first contact pin; and a second contact pin; said container containing said light source and said resistor, said end cap being mounted onto said container, said first and said second contact pin being attached within said end cap, said light source having a first lead and a second lead, said resistor having a first lead and a second lead, said second lead of said light source being connected onto said first lead of said resistor, said second lead of said resistor being connected onto said first contact pin, said first contact pin is in electrical communication with said contact clamp via said second electrical lead of said resistor, said first lead of said light source is connected onto said second contact pin and said second contact pin is in electrical communication with said contact nut via said first electrical lead of said light source.
